(19) United States
(12) Patent Application Publication
(10) Pub. No.: US 2024/0286703 A1
(43) Pub. Date: Aug. 29, 2024

(54) HEAD TUBE ASSEMBLY

(71) Applicant: Huei-Chen LAI, Taichung City (TW)

(72) Inventor: Huei-Chen LAI, Taichung City (TW)

(21) Appl. No.: 18/338,989

(22) Filed: Jun. 21, 2023

(30) Foreign Application Priority Data
Feb. 24, 2023 (TW) 112107055

(51) Int. Cl. B62K 21/06; B62K 21/08

(52) U.S. Cl. CPC B62K 21/06; B62K 21/08

(57) ABSTRACT

A head tube assembly mounted between a head tube and a front fork of a vehicle includes a cup member, an abutment member, and a damping unit. The cup member is mounted fixedly to the head tube. The abutment member is connected co-rotatably to the front fork extending through and rotatable relative to the head tube about an axis. The damping unit is disposed between the cup member and the abutment member, is connected to the abutment member, and includes an outer seat, an inner seat, and a bushing. The outer seat is fixedly connected to the cup member. The inner seat is connected co-rotatably to the abutment member. The bushing is mounted on the axis between the outer seat and the inner seat. The outer seat and the inner seat are in contact with the bushing and rotatable relative to the bushing about the axis.

### CROSS-REFERENCE TO RELATED APPLICATION

This application claims priority to Taiwanese Invention patent application Ser. No. 11/210,7055, filed on Feb. 24, 2023.

### FIELD

The disclosure relates to a head tube assembly, and more particularly to a head tube assembly to be mounted to a vehicle.

### BACKGROUND

Referring to FIGS. 1 and 2, a head tube assembly 9 disclosed in U.S. Pat. No. 10,421,517 is rotatably connected between a steering tube 901 and a head tube 902 of a vehicle (not shown), and provides a damping effect. The steering tube 901 is sleeved on and rotatable relative to the head tube 902. The head tube assembly 9 includes a connecting ring 91, a cup 92, a bearing unit 93, a damping unit 94, and a top cover 95. The connecting ring 91 is co-rotatably connected to the steering tube 901. The cup 92 is connected fixedly to the head tube 902, is driven thereby to rotate with the head tube 902, and includes a main body 921 having an inner surface that defines a channel 922. The bearing unit 93 is disposed in the cup 92. The damping unit 94 is disposed between the cup 92 and the steering tube 901. The top cover 95 is sleeved on and covers a portion of the cup 92 and is connected co-rotatably to the steering tube 901. The connecting ring 91 includes a body 911 having an outer surface that defines an annular passage 912. The damping unit 94 has a plurality of first damping elements 96 connected co-rotatably to the steering tube 901, and a plurality of second damping elements 97 connected co-rotatably to the head tube 902. The first damping elements 96 and the second damping elements 97 are alternatingly disposed and are connected to each other. Thus, each of the first damping elements 96 is adjacent to at least one of the second damping elements 97, and each of the second damping elements 97 is adjacent to at least one of the first damping elements 96. Each of the first damping elements 96 has a first disc portion 961 and a first coupling portion 962. For each of the first damping elements 96, the first disc portion 961 has an outer surface 963, and an inner surface (not shown) radially opposite to the outer surface 963 and defining a central hole (not shown). For each of the first damping elements 96, the first coupling portion 962 extends from the inner surface of the first disc portion 961 toward the steering tube 901 and into the passage 912 of the connecting ring 91, and engages the body 911 of the connecting ring 91 such that the first damping element 96 is driven to rotate when the connecting ring 91 is rotated by the steering tube 901. Each of the second damping elements 97 has a second disc portion 971 and a second coupling portion 972. For each of the second damping elements 97, the second disc portion 971 has an inner surface 974 defining a hole 975 and an outer surface 973 radially opposite to the inner surface 974, the second coupling portion 972 is a tab and extends from the outer surface 973 of the second disc portion 971 away from the hole 975 into the channel 922 of the cup 92 and engages the main body 921 of the cup 92 such that the second damping element 97 is driven to rotate when the cup 92 is rotated.

However, the structure of the damping unit 94 of the conventional head tube assembly 9 is relatively complex, in particular to the structure of the first damping elements 96 and the second damping elements 97 that are stacked alternatingly. Furthermore, since each of the first damping elements 96 is connected to the body 911 of the connecting ring 91 and each the second damping elements 97 is connected to the main body 921 of the cup 92, it is troublesome to sequentially assemble the damping unit 94. Consequently, it is troublesome to disassemble the first damping elements 96 and the second damping elements 97 one by one for maintenance or repair of the damping unit 94. Such procedure is time-consuming and inconvenient.

### SUMMARY

Therefore, an object of the disclosure is to provide a head tube assembly that can alleviate at least one of the drawbacks of the prior art.

According to the disclosure, a head tube assembly is adapted to be mounted between a head tube and a front fork of a vehicle. The front fork extends through the head tube and the head tube assembly, and is rotatable relative to the head tube about an axis. The head tube assembly includes a cup member, an abutment member, and a damping unit. The cup member is adapted to be mounted fixedly to the head tube. The abutment member is adapted to be connected co-rotatably to the front fork. The damping unit is disposed between the cup member and the abutment member, is connected to the abutment member, and includes an outer seat, an inner seat, and a bushing. The outer seat is fixedly connected to the cup member. The inner seat is connected co-rotatably to the abutment member. The bushing is mounted on the axis between the outer seat and the inner seat. The outer seat and the inner seat are in contact with the bushing and rotatable relative to the bushing about the axis.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary cutaway perspective view of a conventional head tube disclosed in U.S. Pat. No. 10,421,517.

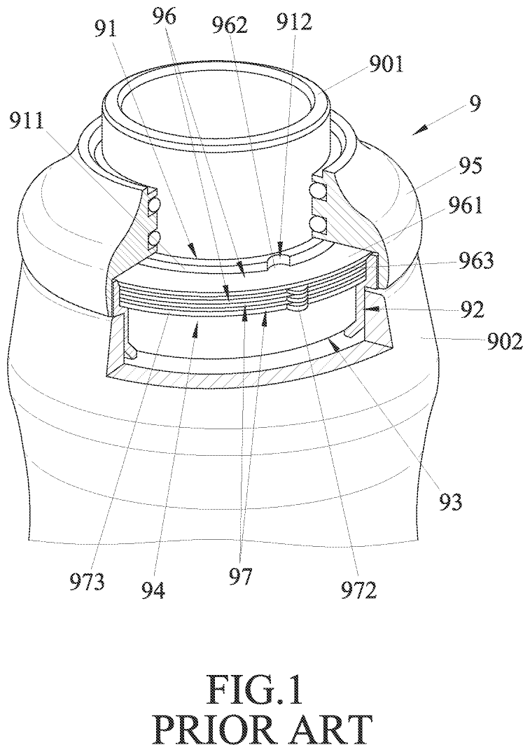

FIG. 2 is a fragmentary sectional view of the conventional head tube disclosed in U.S. Pat. No. 10,421,517.

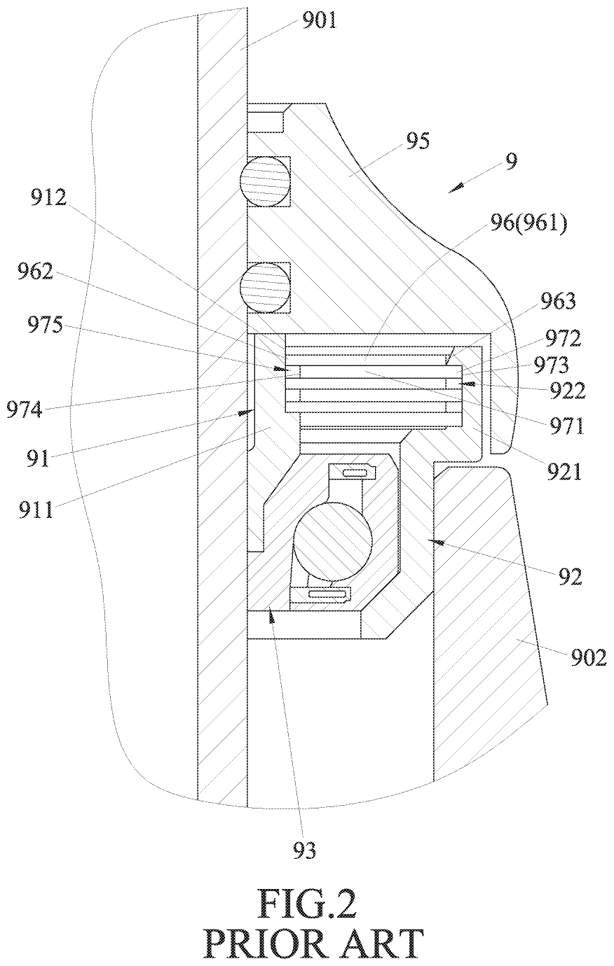

FIG. 3 is a perspective view of a head tube assembly of an embodiment according to the present disclosure being mounted to a head tube and a front fork of a vehicle.

FIG. 4 is an exploded perspective view of the embodiment.

FIG. 5 is an exploded perspective view of a damping unit of the head tube assembly of the embodiment.

FIG. 6 is another exploded perspective view of the damping unit seen from another view of angle different from FIG. 5.

FIG. 7 is a fragmentary sectional view of the embodiment.

FIG. 8 is a partly enlarged view of FIG. 7.

FIG. 9 is a cutaway perspective view of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently e.g., rotated 90 degrees or at other orientations and the spatially relative terms used herein may be interpreted accordingly.

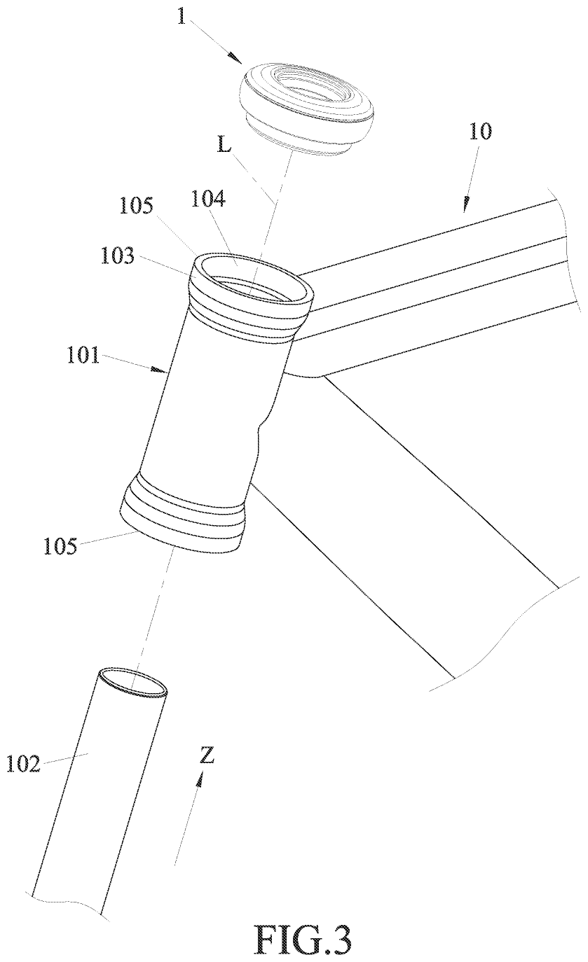

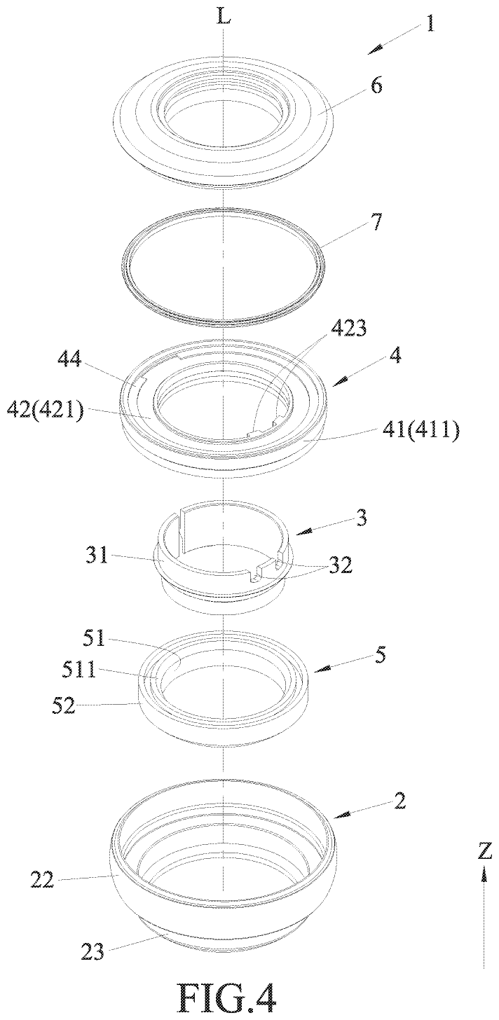

Referring to FIGS. 3 and 4, a head tube assembly 1 of an embodiment according to the present disclosure is adapted to be mounted between a head tube 101 and a front fork 102 of a vehicle 10. In this embodiment, the vehicle 10 is a bicycle (not shown) and is not limited hereto. The front fork 102 extends through the head tube 101 and is rotatable relative to the head tube 101 about an axis (L). The head tube assembly 1 includes a cup member 2, an abutment member 3, a damping unit 4, a bearing unit 5, an end cover 6, and a sealing member 7.

The head tube 101 has an external surrounding surface 103, an inner surrounding surface 104 opposite to the external surrounding surface 103, and two connecting end surfaces 105 connected transversely to the external surrounding surface 103 and the inner surrounding surface 104 and being opposite along the axis (L).

It should be noted that, in this embodiment, the head tube assembly 1 of this disclosure serves as an upper head tube assembly for the vehicle 10 in an up-down direction (Z) of the axis (L), so the head tube assembly 1 is mounted on an upper one of the connecting end surfaces 105 of the head tube 101, but the present disclosure is not limited thereto. In other embodiments, the head tube assembly 1 of this disclosure may be mounted to a lower one of the connecting end surfaces 105 of the head tube 101 in the up-down direction (Z) to serve as a lower head tube assembly for the vehicle 10.

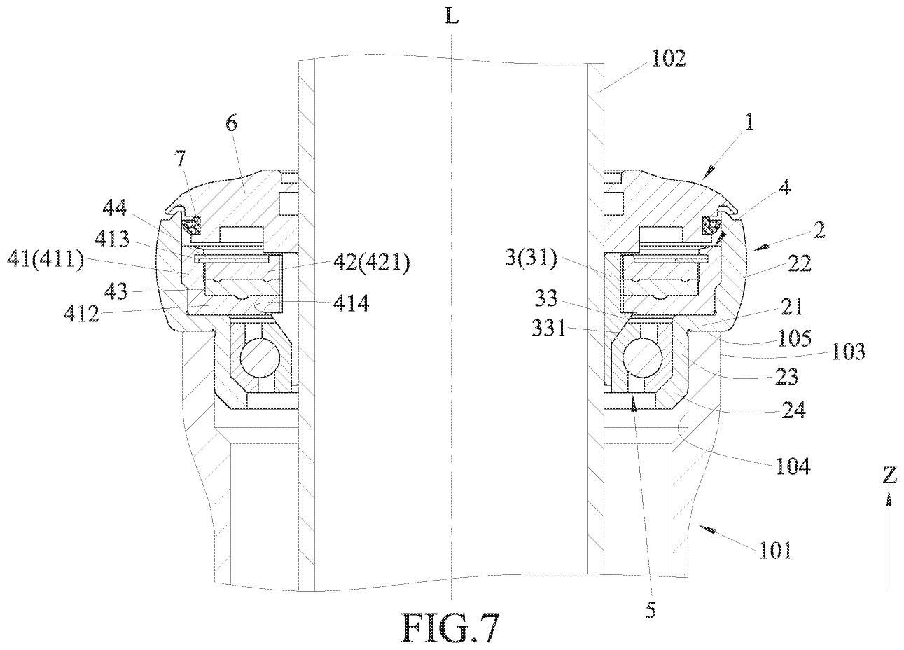

Further referring to FIG. 7, the cup member 2 is adapted to be mounted fixedly to the head tube 101, and includes a mounting wall 21, an enclosing wall 22, a tubular connecting wall 23, and a positioning wall 24. The enclosing wall 22 extends along the axis (L), is sleeved on the damping unit 4, and is adapted to be disposed adjacent to the external surrounding surface 103 of the head tube 101. The mounting wall 21 extends transversely and inwardly from the enclosing wall 22, and is adapted to be seated on the upper one of the connecting end surfaces 105 of the head tube 101. The tubular connecting wall 23 extends downwardly the mounting wall 21 along the axis (L) in a direction opposite to the enclosing wall 22, and is adapted to be surrounded by and abuts against the inner surrounding surface 104 of the head tube 101. The positioning wall 24 extends inclinedly from the tubular connecting wall 23 away from the mounting wall 21.

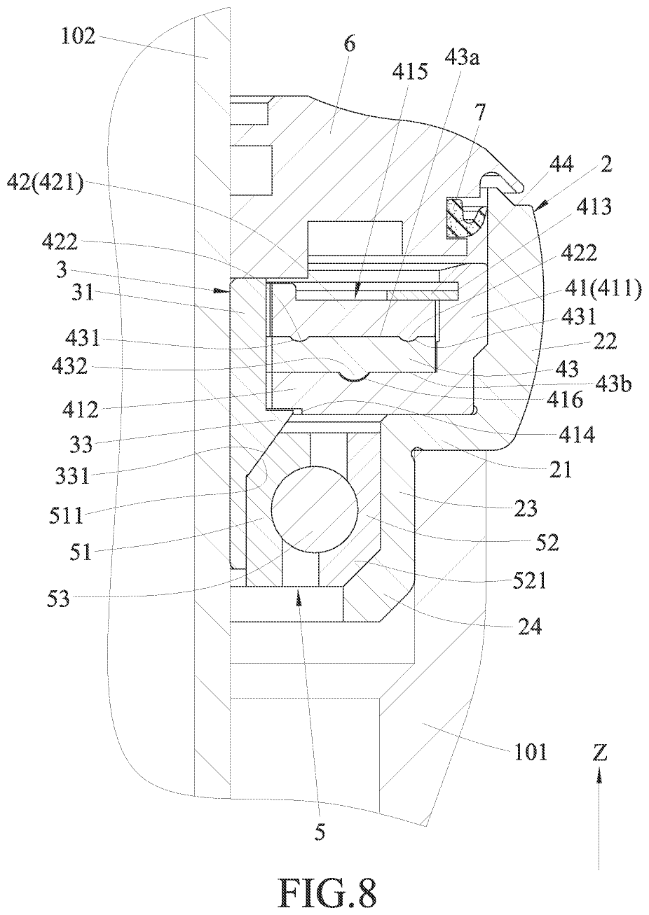

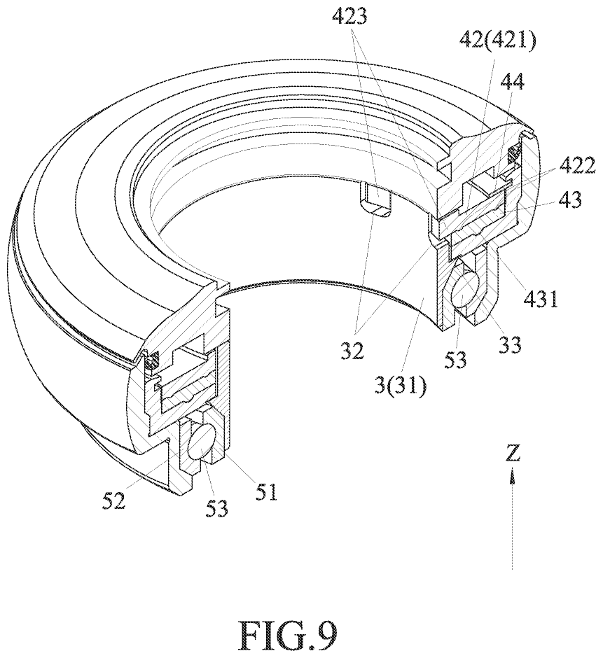

Further referring to FIGS. 8 and 9, the abutment member 3 includes a main body 31, two engaging notches 32, and a flange portion 33. The main body 31 is adapted to be sleeved co-rotatably on the front fork 102. The engaging notches 32 are formed in the main body 31, spaced-apart from each other, and open upwardly. The flange portion 33 extends from the main body 31 toward the cup member 2, and has an inclined surface 331 that is substantially parallel to the positioning wall 24. In this embodiment, the main body 31 is adapted to be fittingly connected to the front fork 102.

As shown in FIGS. 7 and 8, the damping unit 4 is disposed between the cup member 2 and the abutment member 3, is connected to the abutment member 3, and includes an outer seat 41, an inner set 42, a bushing 43, and a retaining member 44. The outer seat 41 is fixedly connected to the cup member 2 and is disposed on the mounting wall 21 of the cup member 2. The inner seat 42 is connected co-rotatably to the abutment member 3. The bushing 43 is mounted on the axis (L) between the outer seat 41 and the inner seat 42. The outer seat 41 and the inner seat 42 are in frictional contact with and rotatable relative to the bushing 43 about the axis (L)

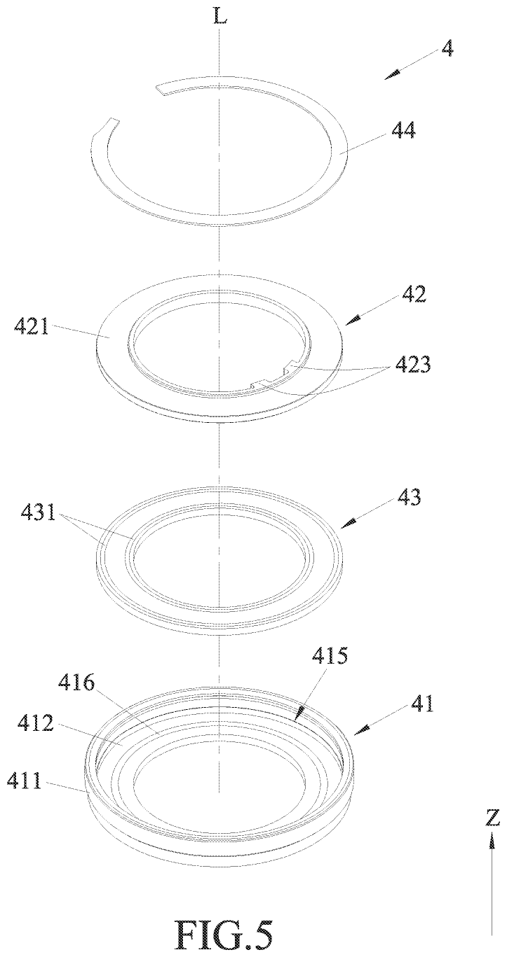

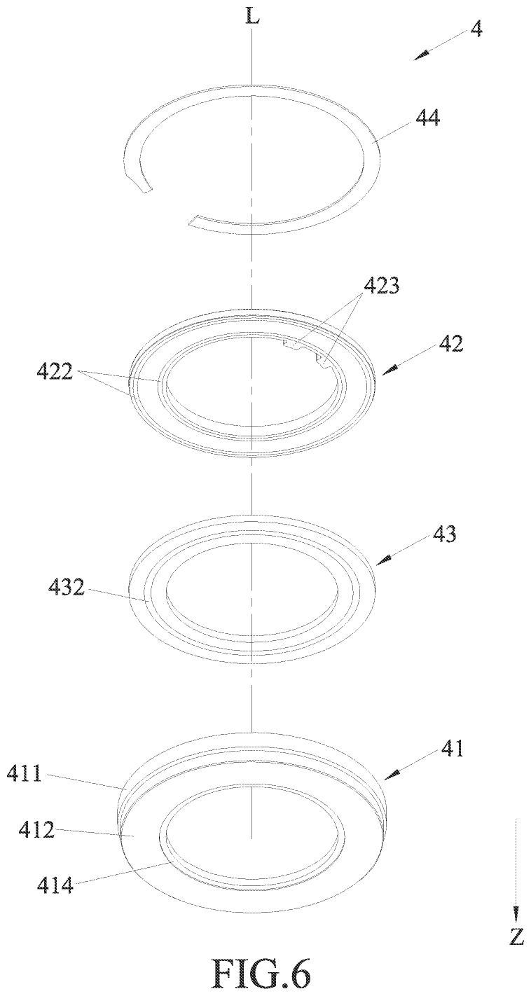

Referring to FIGS. 5, 6 and 8, the outer seat 41 has a surrounding wall 411, a base wall 412, and an engaging groove 413. The surrounding wall 411 extends along the axis (L), is surrounded by and abuts against the enclosing wall 22 of the cup member 2. The base wall 412 extends transversely from the surrounding wall 11 toward the abutment member 3, loops around the abutment member 3, is in frictional contact with the bushing 43, and has a portion seated on the mounting wall 21. The base wall 412 has a receiving groove 414 formed in a lower end of the base wall 412 and open downwardly to receive a portion of the flange portion 33 therein. The base wall 412 and the surrounding wall 411 cooperatively define an accommodating space 415 for accommodation of the inner seat 42 and the bushing 43. The engaging groove 413 is formed in the surrounding wall 411, is distal from the base wall 412 along the axis (L), and is in spatial communication with the accommodating space 415. The retaining member 44 is a C-ring, engages the engaging groove 413, abuts against an upper end surface of the inner seat 42 and the bushing 43 along the axis (L), and retains the inner seat 42 and the bushing 43 in the accommodating space 415. In this way, movement of the inner seat 42 and the bushing 43 in the up-down direction (Z) may be prevented.

As shown in FIG. 9, the inner seat 42 has a seat body 421, two first annular ribs 422, and two engaging blocks 423. The seat body 421 loops around the main body 31 of the abutment member 3, and has a contact surface that is in frictional contact with the bushing 43. The first annular ribs 422 are formed on the contact surface of the seat body 421. The engaging blocks 423 extend from the seat body 421 and engage respectively the engaging notches 32 so that the inner seat 42 is co-rotatable with the abutment member 3 about the axis (L). It should be noted that the number of the engaging blocks 423 and the engaging notches 32 may be only one or more than two, as long as the effect of driving the inner seat 42 to co-rotate with the abutment member 3 may be achieved, and the present disclosure is not limited to this example.

Referring back to FIG. 8, the bushing 43 has a first surface 43a, a second surface 43b, and two first annular grooves 431. The first surface 43a and the second surface 43b are in contact respectively with the inner seat 42 and the outer seat 41 and are opposite along the axis (L). The first annular grooves 431 are formed in the first surface 43a, and are respectively engaged with the first annular ribs 422 of the seat body 421 such that the inner seat 42 and the bushing 43 are concentric to each other. The outer seat 41 has a contact surface that is in frictional contact with the bushing 43 and that is formed with a second annular groove 416. The bushing 43 has a second annular rib 432 formed on the second surface 43b and rotatably engaging the second annular groove 416 such that the outer seat 41 and the bushing 43 are concentric to each other. It should be noted that the number of the first annular ribs 422 and the first annular grooves 431 may be only one or more than two as long as the inner seat 42 and the bushing 43 are concentric to each other, and that the number of the second annular rib 432 and the second annular groove 416 may be only one or more than two as long as the outer seat 41 and the bushing 43 are concentric to each other. The present disclosure is not limited to the number of the first annular ribs 422, the first annular grooves 431, the second annular rib 432 and the second annular groove 416.

Referring to FIGS. 4 and 7 to 9, the bearing unit 5 is a ball bearing and is disposed between the positioning wall 24 and the abutment member 3. The bearing unit 5 includes an inner ring 51 abutting against the flange portion 33 of the abutment member 3, an outer ring 52 connected to and abutting against the tubular connecting wall 23 and the positioning wall 24, and a plurality of rollers 53 disposed between the inner ring 51 and the outer ring 52. Specifically, the inner ring 51 has an upper inclined abutment surface 511 abutting against the inclined surface 331 of the flange portion 33, and the outer ring 52 has a lower inclined abutment surface 521 abutting against the positioning wall 24.

Referring to FIGS. 7 and 8, the end cover 6 is adapted to be connected to the front fork 102, is rotatable with the front fork 102 about the axis (L), and covers the cup member 2. The sealing member 7 is sleeved on the end cover 6 and is clamped between the end cover 6 and the enclosing wall 22 of the cup member 2 so as to prevent liquid from entering the cup member 2 to thereby prevent failure of the damping unit 4.

When the front fork 102 rotates relative to the head tube 101 about the axis (L), the inner seat 42 is driven to rotate with the abutment member 3, and the seat body 421 of the inner seat 42 is in frictional contact with and rotatable relative to the bushing 43 so a damping effect is provided. On the other hand, when the outer seat 41 is driven to rotate with the cup member 2 due to rotation of the head tube 101 relative to the front fork 102 about the axis (L), the base wall 412 is in frictional contact with the bushing 43 and is rotatable relative to the bushing 43 so a damping effect is provided. In this embodiment, a thin layer of grease such as a lubricating oil is applied between the retaining member 44 and the upper end surface of the seat body 421, between the bushing 43 and the outer seat 41, and between the bushing 43 and the inner seat 42 so as to decrease frictional force thereamong and to improve the damping effect of the present disclosure when the front fork 102 rotates relative to the head tube 101 and vice versa.

To assemble the head tube assembly 1 of the present disclosure to the vehicle 10, the front fork 102 is first inserted into the head tube 101, and then the cup member 2 is sleeved on the front fork 103 and is fixedly connected to the upper one of the connecting end surfaces 105 of the head tube 101. Next, the bearing unit 5 is disposed between the tubular connecting wall 23 of the cup member 2 and the front fork 102, and the abutment member 3 is subsequently sleeved on the front fork 102 from a top end of the front fork 102 that is distal from the positioning wall 24 along the axis (L) until the inclined surface 331 of the flange portion 33 abuts against the upper inclined abutment surface 511 of the inner ring 51 of the bearing unit 5 and the lower inclined abutment surface 521 of the outer ring 52 of the bearing unit 5 abuts against the positioning wall 24. Hereafter, the damping unit 4, which is assembled in advance, is disposed between the cup member 2 and the abutment member 3. Specifically, a portion of the base wall 412 of the damping unit 4 is seated on the mounting wall 21, the receiving groove 414 of the base wall 412 receives a portion of the flange portion 33 therein, the surrounding wall 411 of the damping unit 4 is surrounded by and abuts against the enclosing wall 22, and the engaging blocks 423 of the inner seat 42 respectively engage the engaging notches 32 of the abutment member 3. Finally, the end cover 6 on which the sealing member 7 is sleeved is sleeved on the front fork 102 to cover the cup member 2 to complete assembly of the head tube assembly 1 to the vehicle 10.

Generally, engagement among the seat body 421 of the inner seat 42, the base wall 412 of the outer seat 41, the bushing 43, and the main body 31 of the abutment member 3 may become too tight to disassemble after a period of use. Therefore, before the damping unit 4 is to be mounted to the cup member 2 and engages the main body 31 of the abutment member 3, a thin layer of grease is applied on the seat body 421, the base wall 412, and the bushing 43. Alternatively, a thin layer of grease is applied on an outer surface of the main body 31 that is to be in contact with the seat body 421, the base wall 412, and the bushing 43. In this way, the grease may facilitate detachment of the damping unit 4 from the abutment member 3 for maintenance.

As shown in FIGS. 5 to 7, it should be noted that, the damping unit 4 has a relatively simple structure and may be assembled independently and separately from other components of the head tube assembly 1. During assembly of the damping unit 4 that is performed in advance of mounting of the head tube assembly 1 to the vehicle 10, the bushing 43 is first placed in the accommodating space 415 and is seated on the base wall 412, and then the inner seat 42 is brought into the accommodating space 415 to be disposed on the bushing 43. Finally, the retaining member 44 is disposed in the engaging groove 413 and abuts against the upper end surface of the inner seat 42 to retain the inner seat 42 and the bushing 43 in the accommodating space 415. As shown in FIG. 8, by virtue of the second annular rib 432 that engages the second annular groove 416 of the base wall 412, the bushing 43 is positioned on the base wall 412 in a manner that the outer seat 41 is concentric to the bushing 43. Similarly, the structure of the first annular ribs 422 respectively engaging the first annular grooves 431 of the bushing 43 enables the inner seat 42 and the bushing 43 being concentric to each other.

In summary, by virtue of the damping unit 4 that has a relatively simple structure and that may be assembled independently and separately from other components of the head tube assembly 1, it is easy to assemble the head tube assembly 1 of the present disclosure to the vehicle 10 and maintenance of the head tube assembly 1 is simple and convenient.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A head tube assembly adapted to be mounted between a head tube and a front fork of a vehicle, the front fork extending through the head tube and said head tube assembly and rotatable relative to the head tube about an axis, said head tube assembly comprising:
a cup member adapted to be mounted fixedly to the head tube;
an abutment member adapted to be connected co-rotatably to the front fork; and
a damping unit disposed between said cup member and said abutment member, connected to said abutment member, and including
an outer seat that is fixedly connected to said cup member,
an inner seat that is connected co-rotatably to said abutment member, and
a bushing that is mounted on the axis between said outer seat and said inner seat, said outer seat and said inner seat being in frictional contact with said bushing and rotatable relative to said bushing about the axis.

2. The head tube assembly as claimed in claim 1, wherein said outer seat has:
a surrounding wall extending along the axis, and being surrounded by and abutting against said cup member; and
a base wall extending transversely from said surrounding wall toward said abutment member, looped around said abutment member, and being in frictional contact with said bushing, said surrounding wall and said base wall cooperatively defining an accommodating space for accommodation of said inner seat and said bushing.

3. The head tube assembly as claimed in claim 2, wherein:
said outer seat further has an engaging groove formed in said surrounding wall, being distal from said base wall along the axis, and being in spatial communication with said accommodating space; and
said damping unit further includes a retaining member engaging said engaging groove, abutting against said inner seat along the axis, and retaining said inner seat and said bushing in said accommodating space.

4. The head tube assembly as claimed in claim 1, wherein:
said inner seat includes
a seat body looped around said abutment member, and having a contact surface that is in frictional contact with said bushing, and
at least one first annular rib formed on said contact surface of said seat body; and
said bushing has
a first surface being in frictional contact with said contact surface of said seat body, and
at least one first annular groove formed in said first surface, and being engaged with said at least one first annular rib such that said inner seat and said bushing are concentric to each other.

5. The head tube assembly as claimed in claim 1, wherein:
said outer seat has a contact surface being in frictional contact with said bushing and formed with a second annular groove; and
said bushing has
a second surface being in frictional contact with said contact surface of said outer seat, and
a second annular rib formed on said second surface of said bushing, and rotatably engaging said second annular groove such that said outer seat and said bushing are concentric to each other.

6. The head tube assembly as claimed in claim 1, wherein:
said abutment member has
a main body adapted to be sleeved co-rotatably on the front fork, and
at least one engaging notch formed in said main body; and
said inner seat includes
a seat body looped around said main body of said abutment member, and
at least one engaging block extending from said seat body and engaging said at least one engaging notch so that said inner seat is co-rotatable with said abutment member about the axis.

7. The head tube assembly as claimed in claim 1, wherein said cup member includes:
an enclosing wall extending along the axis, sleeved on said outer seat, and adapted to be disposed adjacent to an external surrounding surface of the head tube;
a mounting wall extending transversely and inwardly from said enclosing wall and adapted to be seated on a connecting end surface of the head tube that is disposed at an end of the head tube and that is connected transversely to the external surrounding surface, said outer seat being disposed on said mounting wall; and
a tubular connecting wall extending from said mounting wall along the axis in a direction opposite to said enclosing wall, and adapted to be surrounded by and abut against an inner surrounding surface of the head tube that is connected transversely to the connecting end surface and that is opposite to the external surrounding surface.

8. The head tube assembly as claimed in claim 7, wherein:
said cup member further includes a positioning wall extending inclinedly from said tubular connecting wall away from said mounting wall;
said abutment member includes
a main body adapted to be sleeved co-rotatably on the front fork, and
a flange portion extending from said main body toward said cup member, and having an inclined surface that is substantially parallel to said positioning wall; and
said head tube assembly further comprises a bearing unit disposed between said positioning wall and said inclined surface.

9. The head tube assembly as claimed in claim 1, further comprising:
an end cover adapted to be connected to the front fork, co-rotatable with the front fork about the axis, and covering said cup member; and
a sealing member sleeved on said end cover and clamped between said end cover and said cup member.

10. The head tube assembly as claimed in claim 1, wherein:
a thin layer of grease is applied between said bushing and said inner housing seat; and
a thin layer of grease is applied between said bushing and said outer housing seat.
